(19) United States
(12) Patent Application Publication
(10) Pub. No.: US 2005/0143057 A1
(43) Pub. Date: Jun. 30, 2005

(54) Method for forwarding call from cellular phone to IP phone

(76) Inventors: Makoto Shiraga, Yokohama (JP); Hiroko Ishii, Yokohama (JP); Takuya Fujiki, Yokohama (JP)

Correspondence Address: KATTEN MUCHIN ZAVIS ROSENMAN, 575 MADISON AVENUE, NEW YORK, NY, 10022-2585, US

(21) Appl. No.: 10/849,344

(22) Filed: May 19, 2004

(30) Foreign Application Priority Data
Dec. 26, 2003 (JP) 2003-434932

(51) Int. Cl. H04M 3/42

(52) U.S. Cl. 455/417; 455/415

(57) ABSTRACT

To provide a method for forwarding a call which enables a connection between a called cellular phone and an IP phone, to which the incoming call is to be forwarded, by wireless communication, a method is provided for forwarding a call from the cellular phone to the IP phone in a communication system in which speech communication is carried out on an Internet Protocol network, comprising a first step in which during a call or a speech communication to the called cellular phone from a calling IP phone, a called person operates the called IP phone, to which the incoming call is to be forwarded, whereby a wireless communication is carried out between the called IP phone and the called cellular phone, and a second step in which after the first step, a function built in the called IP phone automatically performs communication with the calling IP phone, so that the incoming call to the called cellular phone is wirelessly forwarded to the called IP phone.

### CROSS-REFERENCE TO RELATED APPLICATIONS

This application is based upon and claims a priority of Japanese Patent Application No. 2003-434932, filed on Dec. 26, 2003, the contents being incorporated herein by reference.

### BACKGROUND OF THE INVENTION

1. Field of the Invention

The present invention relates to a method for forwarding a call from a cellular phone to an IP phone in which a call from an IP phone to a cellular phone using a public network is forwarded to another IP phone, in a VoIP (Voice over Internet Protocol) network. The VoIP is known as a technology to convert speech to IP packets. Each packet constitute a unit of data.

2. Description of the Related Art

Recently, the broadbandization of access lines through xDSL, Cable Internet, an optical fiber, radio transmission or the like and the sophistication of network-related devices have been promoted, and the diffusion thereof has been also accelerated. Various applications and services are provided through an IP (Internet Protocol) network.

Particularly, an IP phone (Internet Protocol phone) service has been used to provide a phone-call speech service on the IP network using the VoIP technology to transmit speech using IP. The IP phone can be lower in cost, compared with an existing phone, and the IP phone will increasingly spread, in accordance with the development of the network technology, in the future.

With the future diffusion of the IP phone, it is expected that those who use both an IP phone service and a cellular phone service will be increased. For example, in a company, an in-house IP phone system covering all the offices will be built while the employees will carry cellular phones for personal contact and move between the offices and work therein.

However, the calling rate of a call between the IP phone and the cellular phone is higher than that between the cellular phones. As a prior art to solve this problem, there is a system disclosed in an international application PCT/JP02/08850 filed on Aug. 30, 2002 by the applicant of this application.

FIG. 1 is a schematic block diagram showing the structure of the prior art system.

In FIG. 1, numeral 10 represents a calling IP phone, numeral 20 represents a called cellular phone, numeral 30 represents a called IP phone, numeral 40 represents a speech control server, and numeral 45 represents an IP network.

The speech server 40 is called a call agent and functions as, for example, a software version of a switchboard in the company. The speech server 40 is provided with a phone connection information storage managing unit 41 and a communication controlling unit 42.

The IP phone 30 is comprised of a connection controlling unit 31 which reads the phone number of a connected cellular phone and a phone connection information notifying unit 32 to notify the speech server 40 of phone connection information including the cellular phone number. The IP phone is known as a phone which is connected to the IP network and which is operated by software.

When the calling IP phone 10 makes a call to the cellular phone 20, the speech control server 40 executes the switching function by the phone connection information storage managing unit 41 and the communication controlling unit 42 therein to send a call to the cellular phone via a public network (not shown). A holder of the cellular phone 20 makes a wire connection physically to an IP phone 30 nearby to save the call charge of the calling IP phone 10. The IP phone 30 notifies the speech server 40 of the phone connection information including the phone number. Consequently, the speech server 40 connects the calling IP phone 10 and the called IP phone 30 via the IP network 45 so that the communication between the IP phones can be established.

[Patent Literature 1] Japanese Kokai No. 9-044396

[Patent Literature 2] Japanese Kokai No. 10-135968

[Patent Literature 3] Japanese Kokai No. 11-317072

[Patent Literature 4] Japanese Kokai No. 2002-199029

[Patent Literature 5] Specification of PCT/JP02/08850

[Invention Disclosure]

[Problems to be Solved by the Invention]

In the above prior art, if the call from the calling IP phone 10 to the called IP phone 20 is forwarded to the IP phone 30 during calling or speaking, the called cellular phone 20 must be physically connected to the to-be-forwarded IP phone 30 with a wire.

However, the holder of the called cellular phone 20 is not always near the IP phone 30 to which the incoming call is to be forwarded. If the called cellular phone 20 receives a phone call when its holder is far from the IP phone 30 to which the incoming cell is to be forwarded, no physical wire connection with the IP phone 30 to which the incoming call is to be forwarded is possible. Therefore, the speech has to be carried out between the calling IP phone 10 and the called cellular phone 20, and high call fees would be charged to the calling IP phone 10.

### SUMMARY OF THE INVENTION

The present invention is aimed to solve the above problems in the prior art, by making it possible to connect the called cellular phone and the IP phone to which the incoming call is to be forwarded, at an application level, using wireless communication.

To achieve the above purpose, according to a first aspect of the present invention, there is provided a method for forwarding an incoming call from a cellular phone to an IP phone in a communication system in which speech communication is carried out on an Internet Protocol network, comprising
a first step in which, when a call arrives at a called cellular phone from a calling IP phone, a called person operates a called IP phone, to which the incoming call is to be forwarded, whereby a wireless communication is carried out between the called IP phone and the called cellular phone, and
a second step in which, after the first step, a function built into the called IP phone to which the incoming call is to be forwarded, automatically performs communication with the calling IP phone,
so that the incoming call to the called cellular phone is wirelessly forwarded to the called IP phone to be forwarded.

According to a second aspect of the present invention, there is provided
a method for switching a call from a cellular phone to an IP phone in a communication system in which a speech communication is carried out on an Internet Protocol network, comprising
a first step in which, when a call arrives at a called cellular phone from a calling IP phone, the called person operates a called IP phone, to which the incoming call is to be forwarded, whereby a wireless communication is carried out between the called IP phone and the called cellular phone,
a second step in which after the first step, a function built into the called IP phone, to which the incoming call is to be forwarded, automatically performs communication with the calling IP phone,
a third step in which the function built in the called IP phone which is communicating with the cellular phone interrupts the communication,
a fourth step in which the IP phone which has been communicating with the cellular phone makes a call to an IP phone, to which the incoming call is to be forwarded, whereby the speech communication is switched to the IP phone to be forwarded.

In the above first or second aspect of the invention, the communication system can be provided with a memory in which an identification number of the IP phone is registered, and a function built into the IP phone, to which the incoming call is to be forwarded, can automatically communicate with the memory and the IP phone in communication in the second step.

In the above first or second aspect of the invention, the communication system can be provided with a memory in which an identification number of the IP phone is registered, and the function built into the IP phone, to which the incoming call is to be forwarded, can automatically communicate with a switching device and the IP phone in communication in the second step.

In the above fourth step in the second aspect of the invention, when the call is switched from the cellular phone to the IP phone to which the incoming call is to be forwarded, the called person can recognize the switching of the call by a ringing tone of the IP phone to be forwarded.

In this invention, as it is not necessary for the IP phone and the cellular phone to be physically connected by a wire, it is advantageous that work for the physical connection between the IP phone and the cellular phone becomes unnecessary. It is also advantageous that it is not necessary to specify a particular IP phone, to which the incoming call is to be forwarded. Concretely, during calling from the IP phone to the cellular phone or during communication between the IP phone to the cellular phone, the nearest IP phone of the holder of the cellular phone is operated so as to provide a call forwarding method to forward the call or speech communication to the IP phone wirelessly.

### BRIEF EXPLANATION OF DRAWINGS

FIG. 1 is a schematic block diagram showing a structure of a conventional system.

FIG. 2 is a schematic block diagram showing a structure of a communication system to carry out a method for forwarding an incoming call from a cellular phone to an IP phone according to an embodiment of the present invention.

FIG. 3 is a structural view showing an entire structure of a system of an embodiment in which the system shown in FIG. 2 is applied to a headquarters and a branch office.

FIG. 4 shows an example of a content in a storage area of an address management server 2 in the branch office 301 in FIG. 3.

FIG. 5 shows caller's number registration data in the cellular phone 6.

FIG. 6 is a part of a flow chart illustrating a process to switch and forward a call received by the cellular phone 6 to an IP phone, to which the incoming call is to be forwarded, according to an embodiment of the present invention.

FIG. 7 is another part of a flow chart illustrating a process to switch and forward a call received by the cellular phone 6 to an IP phone, to which the incoming call is to be forwarded, according to an embodiment of the present invention.

FIG. 8 is a part of a flow chart illustrating a method to forward a call from a cellular phone to an IP phone according to another embodiment of the present invention.

FIG. 9 is another part of a flow chart illustrating a method to forward a call from a cellular phone to an IP phone according to another embodiment of the present invention.

FIG. 10 is a structural view of data transmitted between a cellular phone and an IP phone.

FIG. 11 is a structural view of data to be searched in a storage area.

FIG. 12 is a structural view of data obtained from a storage area.

FIG. 13 is a structural view of broadcast data.

FIG. 14 shows a time sequence illustrating communication established between an IP phone and a cellular phone.

FIG. 15 shows a time sequence illustrating a data transmission between the cellular phone and the IP phone of FIG. 7.

FIG. 16 shows a time sequence illustrating a data transmission between an IP phone and an address management server.

FIG. 17 shows a time sequence illustrating speech communication established between an IP phone 1-1 and an IP phone 5-1.

### BEST MODE FOR CARRYING OUT THE INVENTION

The purpose to enable a connection between the called cellular phone and the forwarded IP phone in an application level wirelessly is realized by wirelessly transferring the incoming call designated to the called cellular phone to the called IP phone, to which the incoming call is to be forwarded, or by wireless communication between the called IP phone, to which the incoming call is to be forwarded, and the cellular phone by operating the called IP phone, to which the incoming call is to be forwarded, during the call between the IP phone and the cellular phone.

### EMBODIMENT 1

Embodiment of the present invention will be explained below with reference to the drawings.

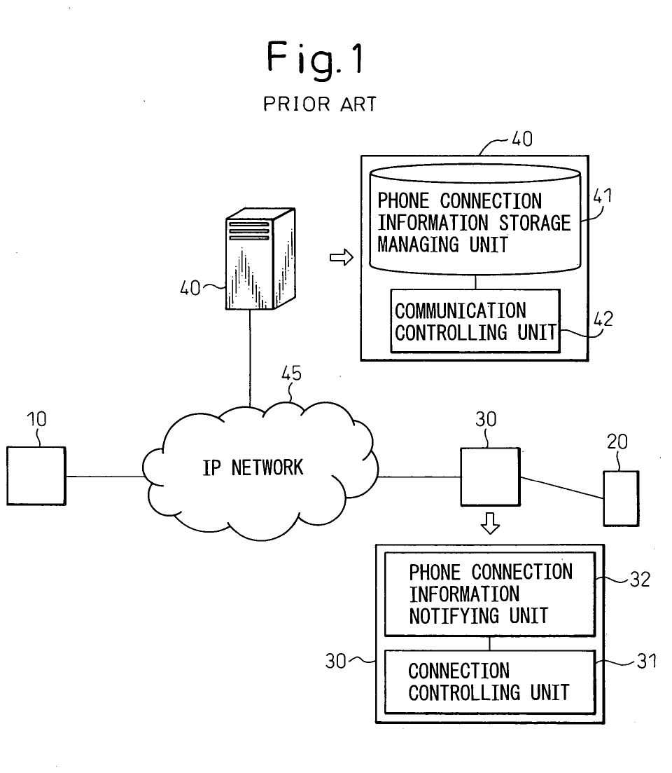

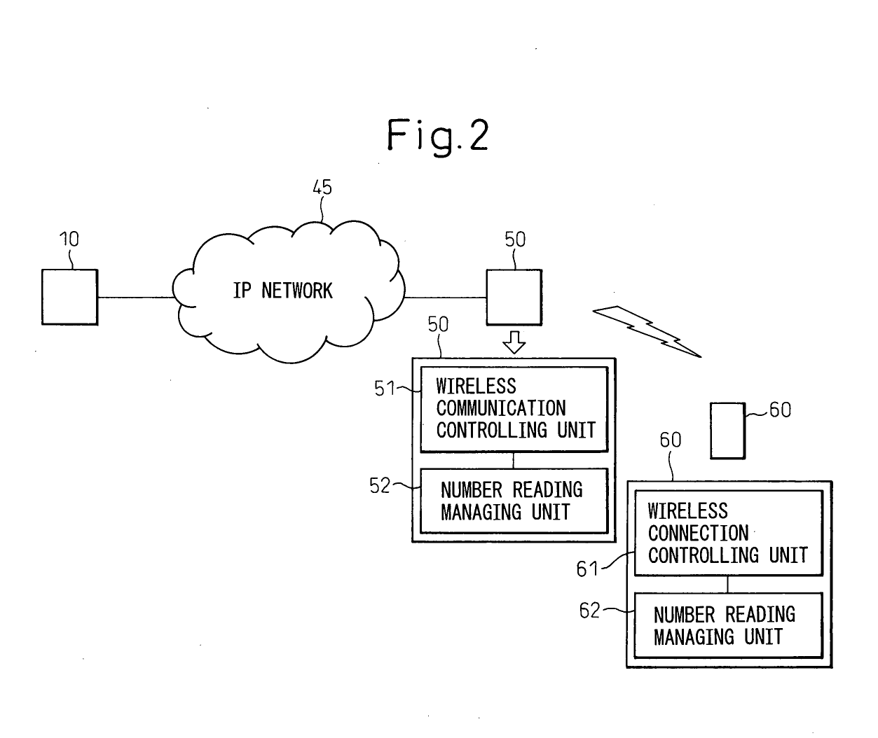

FIG. 2 is a schematic block diagram showing a structure of a communication system to realize a method for forwarding a call from a cellular phone to an IP phone according to an embodiment of the present invention. In FIG. 2, like reference numbers are assigned to components corresponding to those in FIG. 1. Numeral 10 represents the calling IP phone, 45 the IP network, 50 the called IP phone, and 60 the cellular phone. The called IP phone 50 is comprised of a wireless connection controlling unit 51 to carry out wireless communication with the called cellular phone 60 and a number reading managing unit 52 to read the phone number of the cellular phone. The cellular phone 60 is also comprised of a wireless connection controlling unit 61 to carry out wireless communication with the forwarded IP phone 50 and a number reading managing unit 62 to notify the phone number of the cellular phone.

According to the system shown in FIG. 2, the wireless connection interface between the forwarded IP phone 50 and the called cellular phone 60 is controlled by an application.

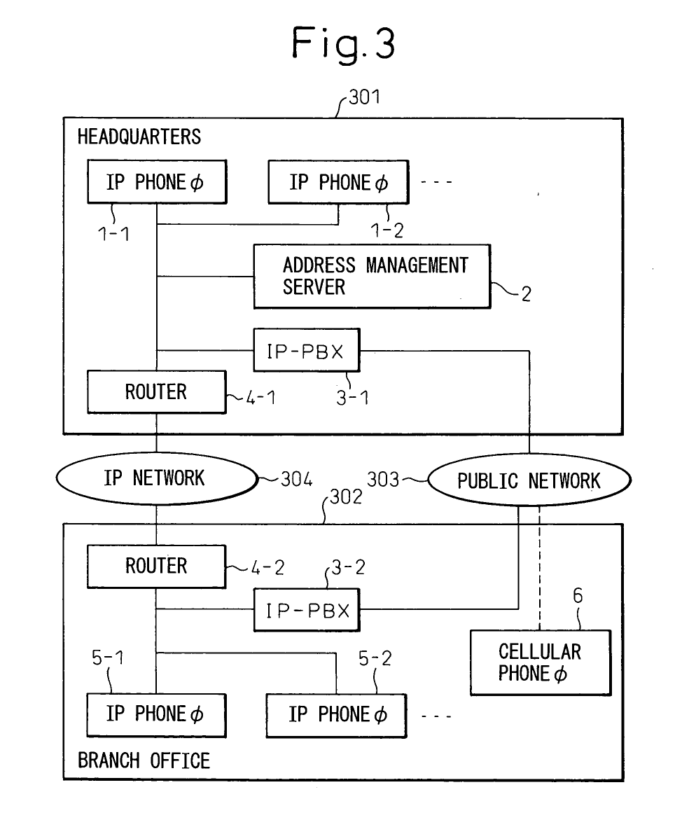

FIG. 3 shows the entire structure of the system of an embodiment applied to a headquarters and a branch office. Only the part essential for the explanation of the present invention is shown in the drawings.

In FIG. 3, in a telephone system of the embodiment, the headquarters 301 and the branch office 302 are connected via a public network 303 and an IP network 304. In the headquarters 301, there are provided IP phones 1-1, 1-2, . . . , an address management server 2 which is a storage device to register identification numbers of the IP phones, and a router 4-1 to connect a private branch exchange IP-PBX 3-1 to the IP network 304. In the branch office 302, there are provided a private branch exchange IP-PBX 3-2, a router 4-2 connected to the IP network 304, and IP phones 5-1, 5-2, . . . . The IP-PBX is required when a LAN is used as an internal phone network and is known as an exchanger directly linked to LAN having an exchange processing function embedded therein between the telephones and terminals. It is assumed that a holder who carries the cellular phone 6 is in the branch office 302.

Speech communication between the headquarters 301 and the branch office 302 can be carried out via the in-house IP network 304 or the public network 303 with VoIP.

The cellular phone 6 in the branch office 302 can carry out speech communication through the public network 303 with the IP phones 1-1, 1-2, . . . in the headquarters 301. The cellular phone 6 can also carry out speech communication with the IP phones 5-2, . . . in the branch office 302 and the other phones by wireless communication. The cellular phone 6 can further carry out data communication with the IP phones 1-1, 1-2, . . . in the headquarters 301 by wireless communication.

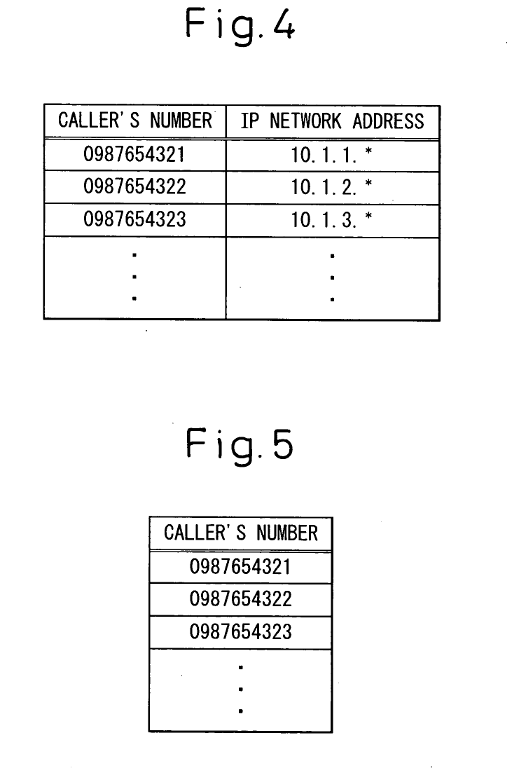

FIG. 4 shows an example of a content in a storage area in the address management server 2 in the headquarters 301 in FIG. 3. It is assumed that in FIG. 4, caller's numbers of the extended IP phones 1-1, 1-2, . . . in the headquarters 301 and the corresponding IP addresses in the IP network containing the extended IP phone numbers are registered in the storage area. The symbol * in FIG. 4 represents a wild card representing an arbitrary value. For example, IP network addresses 10.1.1.1 and 10.1.1.2 corresponding to the caller's number 0987654321 in FIG. 4 are for the IP phones 1-1 and 1-2, respectively. However, the caller's number and the IP network address do not necessarily correspond to each other one-to-one. If the caller's number and the IP network address correspond to each other one-to-one, the address management server 2 is not necessary.

All of the extended IP phones 1-1, 1-2, . . . 5-1, 5-2, and the cellular phone 6 have special applications (indicated by symbol φ in FIG. 3) having a function for wireless communication of the present invention.

FIG. 5 shows registered data of the caller's number in the cellular phone 6.

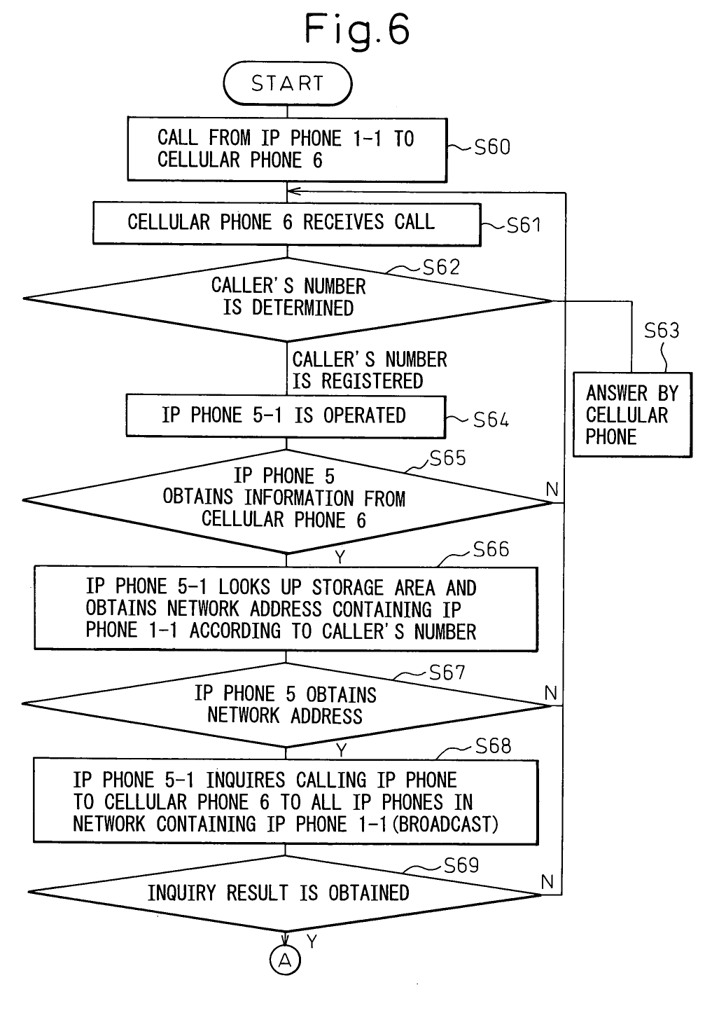

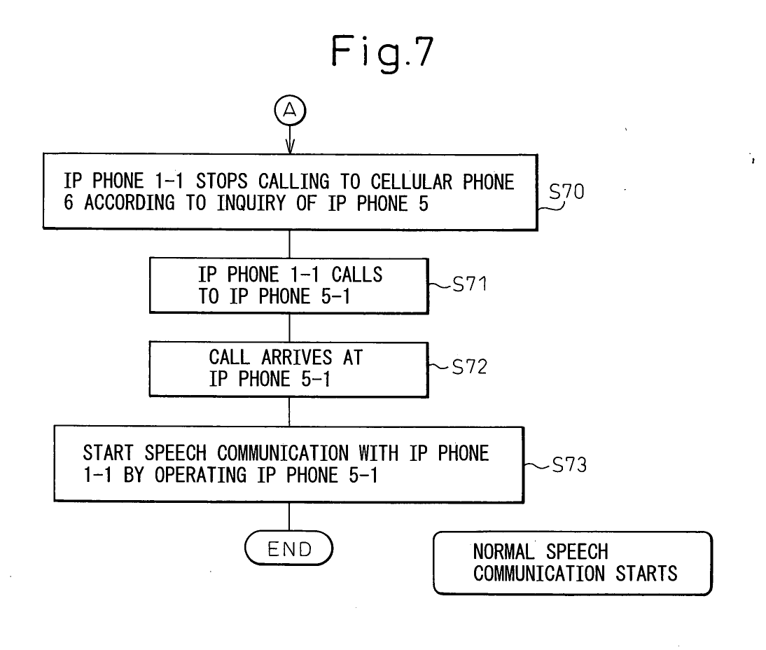

FIG. 6 and FIG. 7 are flow charts illustrating the processes to switch the call to the cellular phone 6 to an extended IP phone to which the incoming call is to be forwarded, during a call from the IP phone of the headquarters 301 or of the branch office 302 to the cellular phone 6, according to the embodiment of the present invention.

FIG. 6 shows the operations to establish a speech communication between the extended IP phone 1-1 in the headquarters 301 and the extended IP phone 5-1 in the branch office 302.

First, a caller in the headquarters 301 calls the cellular phone 6 in the branch office from the IP phone 1-1 in step S60. The cellular phone 6 refers to the data of FIG. 5. If the caller's number is registered, the communication state is started-up as a slave. It is assumed that the cellular phone 6 is not busy.

Next, when the cellular phone 6 is called in step S61, the caller's number is determined in step S62. If the caller's number is not registered in the cellular phone 6, the cellular phone 6 answers the call or ignores the call in step S63.

If the caller's number is registered in the cellular phone 6, the control proceeds to step S64. If the called person of the cellular phone 6 in the branch office 302 operates an extended IP phone to which the incoming call is to be forwarded, for example, 5-1, whereby the cellular phone 6 can be in communication with the extended IP phone 5-1. This process is shown in FIG. 14. Briefly, the IP communication state is set as a master by an application installed in the extended IP phone 5-1, and communication with an application installed in the cellular phone 6 can be established due to Bluetooth communication. At this time, the IP phone 1-1 is still making a call to the cellular phone 6.

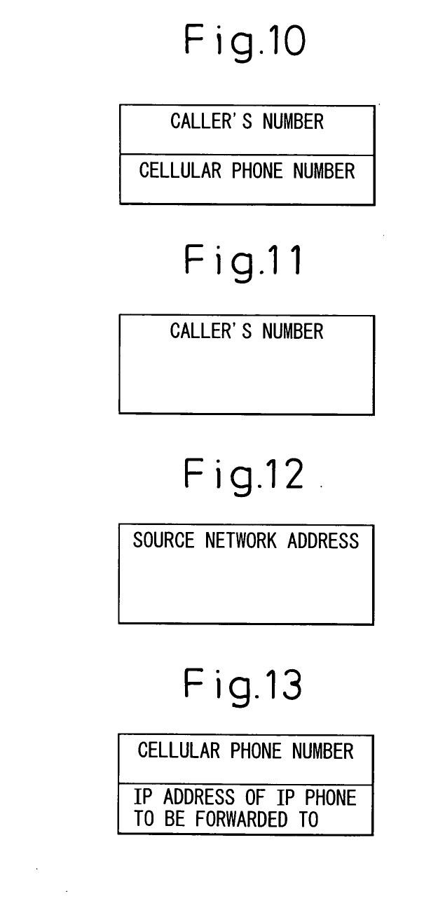

In step S65, information is obtained from the application installed in the cellular phone 6 by the application installed in the IP phone 5-1 by wireless communication. An example of the data to be obtained is shown in FIG. 10. In FIG. 10, data to be transmitted and received between the cellular phone and the IP phone, for example, the caller's number (outside call number of the extended IP phone 1-11) and the phone number of the cellular phone, are shown.

In step S66, the application installed in the IP phone 5-1 searches the storage area of the address management server 2 in a method shown in FIG. 16, according to the data (the caller's number) obtained from the cellular phone 6 and obtains data shown in FIG. 11 (a source network address). This data is a source network address corresponding to the caller's number (a network address of an IP network containing the IP phone 1-1).

According to another embodiment of the present invention, the caller's numbers of the extended phones and the corresponding IP addresses of the IP network including them are registered to obtain the source IP network address from the information, without providing the address management server 2 in the headquarters 301.

FIG. 11 shows a data structure used for the inquiry, and FIG. 12 shows a data structure obtained by the inquiry.

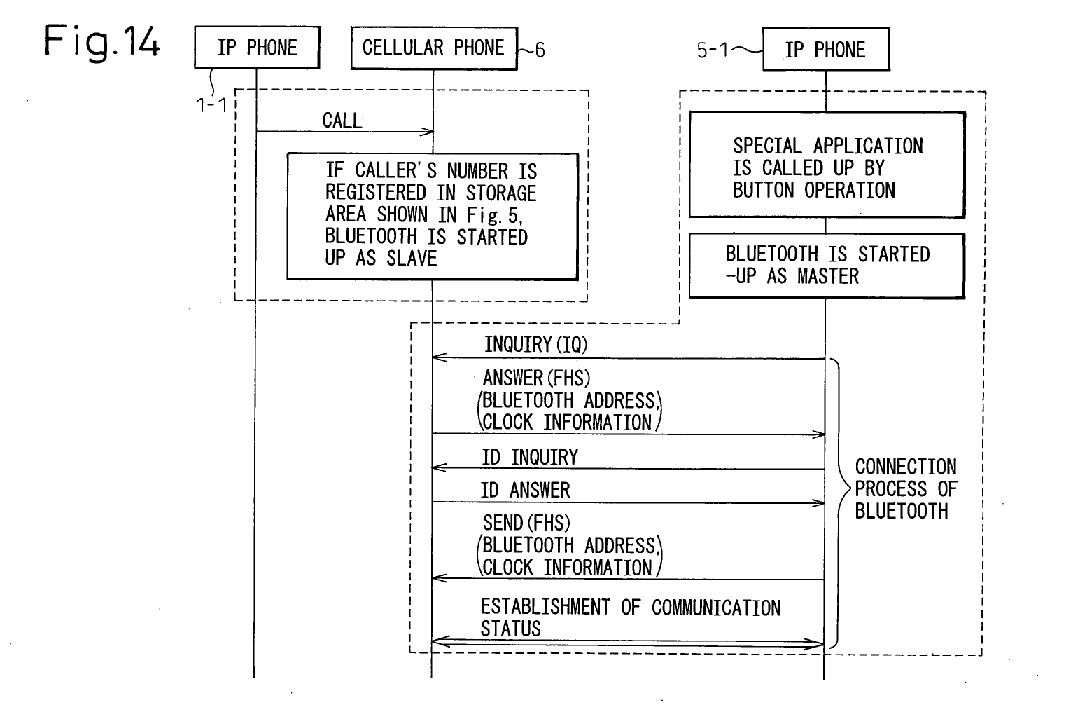

In step S67 following step S66, it is determined whether the extended IP phone 5-1, 5-2, . . . in the branch office 302 have obtained the IP network addresses. If obtained, the application installed in the IP phone 5-1 notifies the data shown in FIG. 13 (the IP addresses of the cellular phone and the IP Phone 5-1 to be forwarded) to all the IP phones in the network including the IP phone 1-1, 1-2, . . . , based on the source network address obtained in the step S66 by broadcasting in step S68, thereby to inquire the calling IP phone. Broadcasting is known as a technology to send data to all the nodes in a particular scope of the network.

In step S69, if it is determined that the extended IP phone 1-1 is calling as a result of the inquiry, the control proceeds to step S70.

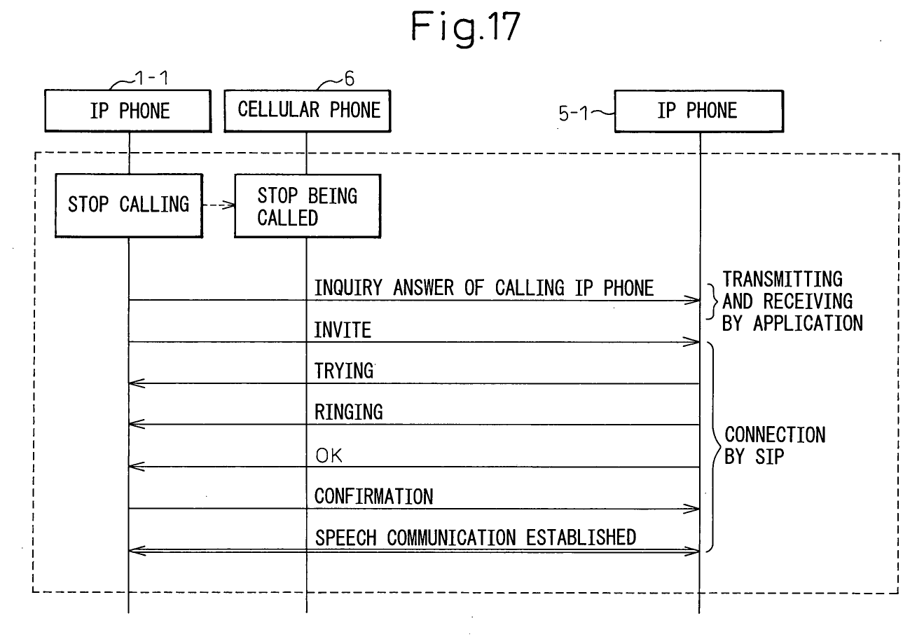

In the step S70, the application installed in the calling IP phone 1-1 notified in the step S68 stops calling to the cellular phone 6 in a method shown in FIG. 17.

In step S71, the IP phone 1-1 in the headquarters 301 requests a connection (makes a call) based on SIP (Session Initiation Protocol) to the IP address of the IP phone 50 in the branch office. SIP is known as a text-base protocol on an application layer to realize a call setting of the phone.

In step S72, the incoming call from the IP phone 1-1 to the cellular phone is stopped and the call arrives the extended IP phone 5-1.

In step S73, the call receiver of the cellular phone 6 in the branch office 302 operates the extended IP phone 5-1 thereby to start the speech connection between the extended IP phone 5-1 and the extended IP phone 1-1.

According to the above process, it is possible to forward an incoming call from the extended phone to the cellular phone to the extended phone nearest thereto.

For the wireless communication between the extended IP phone and the cellular phone, a simple wireless communication means such as Bluetooth, or infrared communication, can be used. Bluetooth is known as an interface standard of a short-range wireless communication.

### EMBODIMENT 2

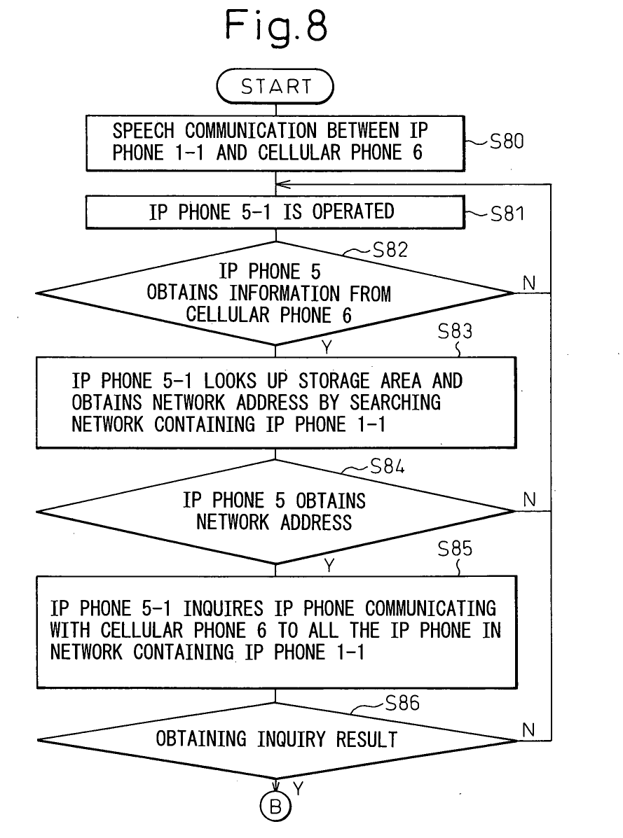

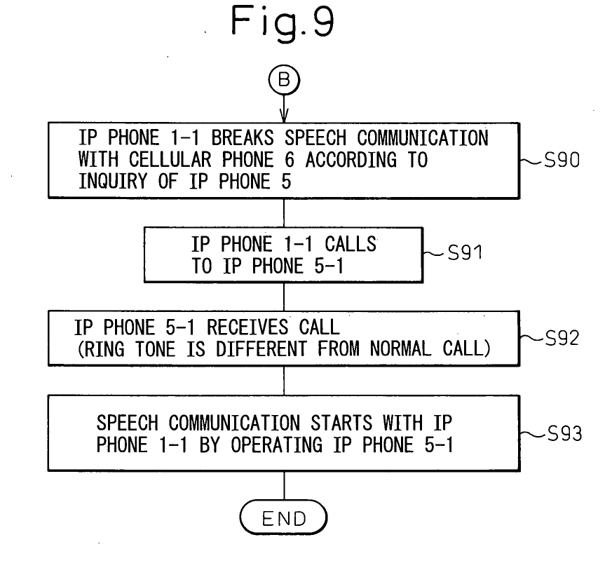

FIG. 8 and FIG. 9 are flow charts illustrating a method for switching and transferring a speech communication from a cellular phone to an extended IP phone according to another embodiment of the present invention.

If the cellular phone 6 is being in speech communication with the extended IP phone 1-1 in step S80, the cellular phone is set-up and in standby mode in a slave state as shown in FIG. 14 with Bluetooth.

A speaker of the cellular phone 6 in the branch office 302 operates the nearest extended IP phone 5-1 to be forwarded. According to the method shown in FIG. 14, the application installed in the extended IP phone 5-1 sets the communication status due to Bluetooth as a master to be able to communicate with the application installed in the cellular phone 6 due to Bluetooth communication. At this time, the connection between the cellular phone 6 and the IP phone 1-1 is reserved.

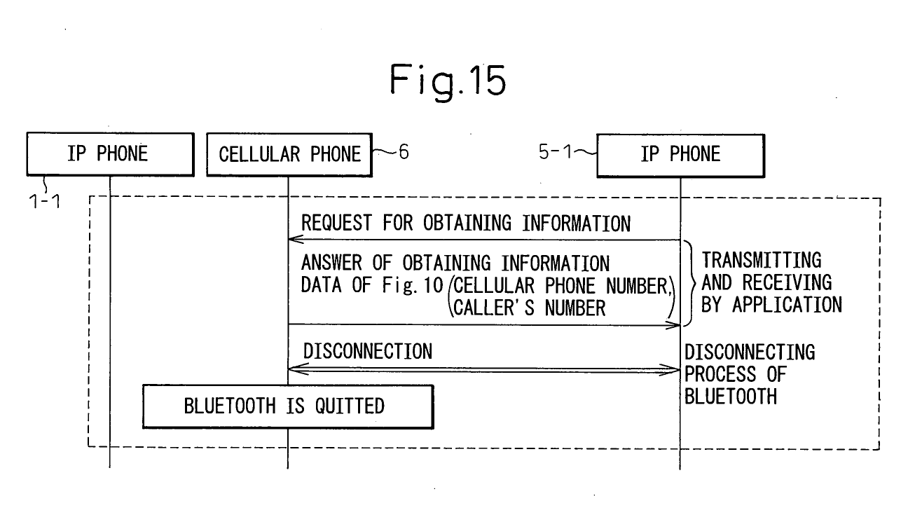

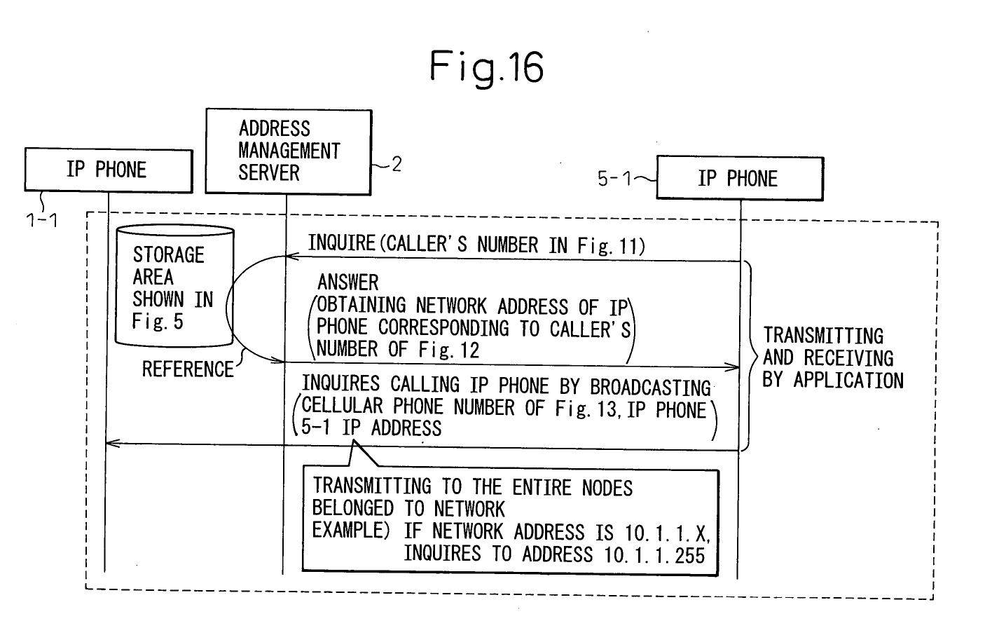

The application installed in the extended IP phone 5-1 obtains data (caller's number (outside phone number of the IP phone 1-1) and the phone number of the cellular phone 6) shown in FIG. 10 from the application installed in the cellular phone 6 by air according to the method shown in FIG. 15.

After obtaining the data, the control proceeds to step S83, in which the application installed in the extended IP phone 5-1 searches the address management server 2 by means shown in FIG. 16 according to the data (the caller's number) shown in FIG. 11 to obtain the data (the source network address) shown in FIG. 12, and to obtain the source network address (the network address of the network containing the IP phone 1-1) corresponding to the obtained caller's number.

In place of the address management server 2, it is possible to register, in advance, the caller's number and the corresponding IP address of the network including the caller's number of the extended IP phone in an internal area of the IP-PBX 3-1, so that the source network address can be obtained based on the information.

In step S85, the application installed in the IP phone 5-1 notifies the data (the phone number of the cellular phone and the IP address of forwarded IP phone 5-1) as shown in FIG. 13 to all the IP phones 1-1, 1-2, . . . in the IP network 340 containing the IP phone 1-1 based on the source network address determined in the step S84 by broadcasting.

In step S86, if the IP phone 1-1 in speech communication obtains the above data, the flow goes to step S90. The application installed in the extended IP phone 1-1 breaks the speech communication with the cellular phone 6 by means shown in FIG. 17, and sends a connection request by SIP to the extended IP phone 5-1 in step S91.

In step S92, the IP phone 5-1 is called. The ring tone of the IP phone 5-1 is set different from that of the normal call, so that the call receiver can easily determine the switching of the call.

In step S93, the speaker of the cellular phone 6 in the branch office 302 operates the extended IP phone 5-1, so that the IP phone 5-1 and the IP phone 1-1 can start the speech communication.

According to the above process, the speech communication between an extended phone and a cellular phone can be forwarded to the extended phone close thereto.

[Industrial Applicability]

(1) Cost

According to the present invention, a call rate, which is the most expensive and is applied a call from a general subscriber phone to a cellular phone, is unnecessary, thus resulting in remarkably reducing the call fee.

(2) Applications

According to the present invention, the calling person can use an extended phone if he/she knows only a cellular phone number, without knowing the extended number, of the called person.

Moreover, the called person can establish a speech communication in real time by operating the extended phone, to which the incoming call is to be forwarded, without physically connecting the cellular phone and the extended phone and registering information in a call control server.

Furthermore, according to the present invention, a calling person can use an extended phone system even if a called person is away from his/her desk (the called person is away from the extended phone whose information is registered in the call control server).

Furthermore, according to the present invention, an extended phone can be used if a calling person knows the cellular phone number in case that the extended phone number is changed due to seat change.

1. A method for forwarding an incoming call from a cellular phone to an IP phone in a communication system in which speech communication is carried out on an Internet Protocol network, comprising
a first step in which, when a call arrives at a called cellular phone from a calling IP phone, a called person operates a called IP phone, to which the incoming call is to be forwarded, whereby a wireless communication is carried out between the called IP phone and the called cellular phone, and
a second step in which, after the first step, a function built in the called IP phone, to which the incoming call is to be forwarded, automatically communicates with the calling IP phone,
so that the incoming call to the called cellular phone is forwarded to the called IP phone to which the incoming call is to be forwarded.

2. A method for forwarding an incoming call according to claim 1, characterized in that the communication system is comprised of a storage device in which an identification number of the IP phone is registered, and, in the second step, the function built in the called IP phone, to which the incoming call is forwarded, automatically communicates with the storage device and the calling IP phone.

3. A method for forwarding an incoming call according to claim 1, in which the communication system is comprised of a switching device in which an identification number of the IP phone is registered, and in the second step, the function built in the called IP phone, to which the incoming call is to be forwarded, automatically communicates with the switching device and the calling IP phone.

4. A method for switching a call from a cellular phone to an IP phone in a communication system in which a speech communication is carried out on an Internet Protocol network, comprised of
a first step in which, when a call arrives at a called cellular phone from a calling IP phone, the called person operates an called IP phone, to which the incoming call is to be forwarded, thereby a wireless communication is carried out between the called IP phone and the called cellular phone,
a second step in which after the first step, a function built in the called IP phone, to which the incoming call is to be forwarded, automatically communicates with the calling IP phone,
a third step in which the function built in the called IP phone which is communicating with the cellular phone disconnects the communication,
a fourth step in which the IP phone which have been communicating with the cellular phone makes a call to the IP phone, to which the incoming call is to be forwarded, thereby the speech communication is switched to the IP phone to which the incoming call is to be forwarded.

5. A communication switching method according to claim 4, in which is comprised of a storage device in which an identification number of the IP phone is registered, and the function built in the called IP phone, to which the incoming call is to be forwarded, automatically communicates with the storage device and the calling IP phone in the second step.

6. A communication switching method according to claim 4, in which, in the fourth step, when the communication is switched from the cellular phone to the IP phone, to which the incoming call is to be forwarded, the person who received the call can recognize the switching by a ringtone of the forwarded IP phone.

7. A communication switching method according to claim 5, in which, in the fourth step, when the communication is switched from the cellular phone to the IP phone, to which the incoming call is to be forwarded, the person who received the call can recognize the switching by the ringtone of the forwarded IP phone.

8. A communication switching method, according to claim 4, wherein the communication system is comprised of a switching device in which an identification number of the IP phone is registered, and, in the second step, the function built in the IP phone, to which the incoming call is to be forwarded, automatically communicates with the switching device and the calling IP phone.

9. A communication switching method according to claim 8, in which, in the fourth step, when the communication is switched from the cellular phone to the IP phone, to which the incoming call is to be forwarded, the person who received the call can recognize the switching by the ringtone of the forwarded IP phone.
